(19) United States
(12) Patent Application Publication
(10) Pub. No.: US 2026/0241770 A1
(43) Pub. Date: Aug. 20, 2026

(54) GAS INJECTION TYPE HEAT MANAGEMENT SYSTEM FOR VEHICLE

(71) Applicants: HYUNDAI MOTOR COMPANY, SEOUL (KR); KIA CORPORATION, SEOUL (KR)

(72) Inventor: Jong Won Kim, Cheonan-si (KR)

(73) Assignees: HYUNDAI MOTOR COMPANY, SEOUL (KR); KIA CORPORATION, SEOUL (KR)

(21) Appl. No.: 19/647,252

(22) Filed: Apr. 14, 2026

Related U.S. Application Data
(62) Division of application No. 17/951,032, filed on Sep. 22, 2022.

(30) Foreign Application Priority Data
Feb. 10, 2022 (KR) 10-2022-0017423

(51) Int. Cl. B60H 1/00; B60H 1/32

(52) U.S. Cl. CPC B60H 1/00921; B60H 1/00899; B60H 1/3213; B60H 1/3228; B60H 2001/00957

(57) ABSTRACT

The present disclosure relates to a gas injection type heat management system for a vehicle, which adopts a heat exchanger capable of reducing the amount of use of a separate heater during an initial heating process by using energy consumed by a compressor during a heating process using heat exchange between circulating refrigerants.

### CROSS REFERENCE TO RELATED APPLICATIONS

The present application is a divisional of U.S. Patent Application No. 17/951,032, filed Sep. 22, 2022, which claims priority to Korean Patent Application No. 10-2022-0017423, filed Feb. 10, 2022, the entire contents of each are incorporated herein for all purposes by this reference.

### BACKGROUND

### Field

The present disclosure relates to a gas injection type heat management system for a vehicle, and more particularly, to a gas injection type heat management system for a vehicle, which adopts a heat exchanger capable of reducing the amount of use of a separate heater during an initial heating process by using energy consumed by a compressor during a heating process using heat exchange between circulating refrigerants.

### Description of the Related Art

Recently, environmental-friendly vehicles such as electric vehicles have come into wide use to solve environmental issues caused by internal combustion engine vehicles. In the case of the internal combustion engine vehicle, waste heat from an engine may be used to heat the interior, which does not require energy for a separate heating process. However, because the electric vehicle has no engine, i.e., a heat source, separate energy is required to perform the heating process, which causes a deterioration in fuel economy. Further, the deterioration in fuel economy decreases a travelable distance of the electric vehicle and causes the vehicle to be frequently charged, which causes discomfort.

Meanwhile, as the vehicle is motorized, there is an additional need to manage not only heat in the interior of the vehicle, but also heat of electrical components such as a high-voltage battery and a motor. That is, in the case of the electric vehicle, the interior space, the battery, and the electrical components have different needs for air conditioning, and thus a technology capable of maximally saving energy by independently coping with and efficiently and cooperatively managing the different needs is required. Therefore, an integrated vehicle heat management concept has been proposed in order to improve thermal efficiency by independently managing heat of the respective components and integrating the heat management of the entire vehicle.

In order to perform the integrated vehicle heat management, complicated coolant lines and components need to be integrated and modularized. To this end, a modularization concept capable of modularizing the plurality of components, simply manufacturing the components, and implementing the compact package is required.

Meanwhile, recently, studies are being actively conducted to improve efficiency of a heat pump of the electric vehicle.

One of the methods of improving the efficiency of the heat pump is the use of a gas injection type heat pump.

The gas injection type heat pump uses a heat exchanger (H/X) or a flash tank and improves heating efficiency of the vehicle by increasing a flow rate of a refrigerant circulating during a heating process.

The foregoing explained as the background is intended merely to aid in the understanding of the background of the present disclosure, and is not intended to mean that the present disclosure falls within the purview of the related art that is already known to those skilled in the art.

### SUMMARY

The present disclosure aims to provide a gas injection type heat management system for a vehicle, which adopts a heat exchanger capable of reducing the amount of use of a separate heater during an initial heating process by using energy consumed by a compressor during a heating process using heat exchange between circulating refrigerants.

The present application provides for improved utilization of energy consumed by a compressor using heat exchange between refrigerants in a gas injection type heat pump system.

Technical problems to be solved by the present disclosure are not limited to the above-mentioned technical problems, and other technical problems, which are not mentioned above, may be clearly understood from the following descriptions by those skilled in the art to which the present disclosure pertains.

An exemplary embodiment of the present disclosure provides a gas injection type heat management system for a vehicle, the gas injection type heat management system including a first refrigerant line in which a compressor, an inner condenser, and a heat exchanger are sequentially provided and a refrigerant flows, a third refrigerant line in which a second branch point is provided at a downstream point of the heat exchanger based on a flow direction of the refrigerant, the third refrigerant line branching off from the second branch point such that the refrigerant flows directly to the compressor via a first expansion valve and the heat exchanger, and in the heat exchanger, the refrigerant discharged from the inner condenser and the refrigerant discharged from the first expansion valve exchange heat with each other, a fourth refrigerant line branching off from a first branch point disposed in the first refrigerant line and provided at a downstream point of the inner condenser based on the flow direction of the refrigerant, the fourth refrigerant line merging into a first junction point disposed in the third refrigerant line and provided at an upstream point of the first expansion valve; and a control unit configured to control whether to operate the compressor and control whether to allow the refrigerant to flow and whether to expand the refrigerant by adjusting an opening degree of the first expansion valve.

A first multi-way valve may be provided at the first branch point in the first refrigerant line and control flows in three directions.

In a first heating mode, the control unit may allow the refrigerant, which flows to the first refrigerant line, to circulate to the third refrigerant line via the second branch point and the first junction point, and the control unit may allow the refrigerant discharged from the first expansion valve to absorb, in the heat exchanger, heat from the refrigerant discharged from the inner condenser.

In the first heating mode, the control unit may operate the compressor so that the compressed refrigerant passes through the inner condenser and radiates heat while exchanging heat with air in the vehicle; the control unit may control an operation of opening or closing the first multi-way valve so that the refrigerant, which has radiated heat while passing through the inner condenser, flows to the heat exchanger and is prevented from flowing to the fourth refrigerant line, such that the refrigerant flows to the third refrigerant line, and the control unit may adjust the opening degree of the first expansion valve so that the refrigerant, which has radiated heat while passing through the inner condenser and has passed through the heat exchanger, is expanded while passing through the first expansion valve and then introduced into the heat exchanger again.

The first heating mode may be a state of COP=1 in which the refrigerant flowing in the first refrigerant line and the refrigerant flowing in the third refrigerant line exchange heat with each other, and the refrigerant flowing in the first refrigerant line and the third refrigerant line does not exchange heat with a separate coolant.

The gas injection type heat management system may further include a second refrigerant line in which a second expansion valve and an evaporator are sequentially provided and the refrigerant flows from the first refrigerant line and circulates to the compressor via the second expansion valve and the evaporator, and the control unit may control whether to allow the refrigerant to flow and whether to expand the refrigerant by adjusting an opening degree of the second expansion valve.

In a second heating mode, the control unit may allow a part of the refrigerant flowing to the first refrigerant line to circulate to the second refrigerant line and the remaining part of the refrigerant to circulate to the third refrigerant line, such that the refrigerant flowing in the second refrigerant line absorbs, in the evaporator, heat from air circulating in the vehicle, and the refrigerant discharged from the first expansion valve absorbs, in the heat exchanger, heat from the refrigerant discharged from the inner condenser.

In the second heating mode, the control unit may operate the compressor so that the compressed refrigerant passes through the inner condenser and radiates heat while exchanging heat with the air in the vehicle, the control unit may control an operation of opening or closing the first multi-way valve so that the refrigerant, which has radiated heat while passing through the inner condenser, flows to the heat exchanger and is prevented from flowing to the fourth refrigerant line, such that the refrigerant flows to the third refrigerant line, the control unit may adjust the opening degree of the first expansion valve so that a part of the refrigerant, which has radiated heat while passing through the inner condenser and has passed through the heat exchanger, is expanded while passing through the first expansion valve and then is introduced into the heat exchanger again; and the control unit may adjust the opening degree of the second expansion valve so that the remaining part of the refrigerant having passed through the heat exchanger is expanded while passing through the second expansion valve and then passes through the evaporator.

The second heating mode may be a state of COP=1 in which the refrigerant flowing in the first refrigerant line and the refrigerant flowing in the third refrigerant line exchange heat with each other, and the refrigerant flowing in the first refrigerant line, the second refrigerant line, and the third refrigerant line does not exchange heat with a separate coolant, and the second heating mode may be a state in which the refrigerant passing through the evaporator exchanges heat with the air circulating in the vehicle.

In a general heating mode, the control unit may allow the refrigerant discharged from the inner condenser through the first refrigerant line to flow through the fourth refrigerant line without heat exchange in the heat exchanger, flow to the second refrigerant line and the third refrigerant line, and then circulate to the first refrigerant line again.

In the general heating mode, the control unit may operate the compressor so that the compressed refrigerant passes through the inner condenser and radiates heat while exchanging heat with the air in the vehicle; the control unit may control the first multi-way valve so that the refrigerant, which has radiated heat while passing through the inner condenser, flows to the fourth refrigerant line, the control unit may fully open the first expansion valve so that a part of the refrigerant having flowed to the fourth refrigerant line flows to the third refrigerant line without being expanded while passing through the first expansion valve or adjusts the opening degree of the first expansion valve so that the refrigerant is expanded while passing through the first expansion valve and then introduced into the third refrigerant line, and the control unit may adjust the opening degree of the second expansion valve so that a part of the refrigerant having flowed to the fourth refrigerant line is expanded while passing through the second expansion valve and then passes through the evaporator.

Another exemplary embodiment of the present disclosure provides a gas injection type heat management system for a vehicle, the gas injection type heat management system including a first refrigerant line in which a compressor, an inner condenser, and a heat exchanger are sequentially provided and a refrigerant flows, a second refrigerant line in which a second expansion valve and an evaporator are sequentially provided such that the refrigerant flows from the first refrigerant line and circulates to the compressor via the second expansion valve and the evaporator, a third refrigerant line in which a first branch point is disposed in the first refrigerant line and provided at a downstream point of the inner condenser based on a flow direction of the refrigerant, the third refrigerant line branching off from the first branch point such that the refrigerant flows to the compressor via a first expansion valve and the heat exchanger, and in the heat exchanger, the refrigerant discharged from the inner condenser and the refrigerant discharged from the first expansion valve exchange heat with each other, and a control unit configured to control whether to operate the compressor and control whether to allow the refrigerant to flow and whether to expand the refrigerant by adjusting an opening degree of the first expansion valve and an opening degree of the second expansion valve.

A heat absorber may be further provided in the third refrigerant line and disposed at a downstream point of the heat exchanger and allow the refrigerant discharged from the inner condenser and the refrigerant flowing in the third refrigerant line to exchange heat with each other, a third branch point may be disposed in the first refrigerant line and provided between the first branch point and the downstream point of the inner condenser based on the flow direction of the refrigerant, a second junction point may be provided between the third branch point and the first branch point, a fifth refrigerant line may be further provided to branch off from the third branch point, pass through the heat absorber, and then merge into the second junction point, and a second multi-way valve may be provided at the third branch point and control flow rates in three directions.

The heat exchanger may perform the heat exchange so that the refrigerant discharged from the first expansion valve absorbs the heat from the refrigerant discharged from the inner condenser.

The evaporator may perform the heat exchange so that the refrigerant flowing in the second refrigerant line absorbs the heat from the air circulating in the vehicle.

In a first heating mode, the control unit may allow the refrigerant flowing to the first refrigerant line to pass through the fifth refrigerant line and then circulate to the third refrigerant line again, and the control unit may prevent the refrigerant from flowing to the heat exchanger and the second refrigerant line, such that in the heat absorber, the refrigerant discharged from the first expansion valve absorbs heat from the refrigerant discharged from the inner condenser.

In the first heating mode, the control unit may operate the compressor so that the compressed refrigerant passes through the inner condenser and radiates heat while exchanging heat with air in the vehicle; the control unit may fully close the second expansion valve so that the refrigerant, which has radiated heat while passing through the inner condenser, flows to the heat absorber and is prevented from flowing to the heat exchanger and the second refrigerant line; the control unit may control an operation of opening or closing the second multi-way valve so that the refrigerant flows to the fifth refrigerant line, and the control unit may adjust the opening degree of the first expansion valve so that the refrigerant, which has radiated heat while passing through the inner condenser, exchanges, in the heat absorber, heat with the refrigerant expanded while passing through the first expansion valve.

The first heating mode may be a state of COP=1 in which the refrigerant flowing in the fifth refrigerant line and the refrigerant flowing in the third refrigerant line exchange heat with each other, and the refrigerant flowing in the fifth refrigerant line and the third refrigerant line does not exchange heat with a separate coolant.

In a second heating mode, the control unit may allow the refrigerant flowing to the first refrigerant line to flow to the fifth refrigerant line, a part of the refrigerant to circulate to the second refrigerant line, and the remaining part of the refrigerant to circulate to the third refrigerant line, such that the refrigerant flowing in the second refrigerant line absorbs, in the evaporator, heat from air circulating in the vehicle, the refrigerant discharged from the first expansion valve absorbs, in the heat absorber, heat from the refrigerant discharged from the inner condenser, and the refrigerant discharged from the first expansion valve absorbs, in the heat exchanger, heat from the refrigerant having passed through the heat absorber through the fifth refrigerant line.

In the second heating mode, the control unit may operate the compressor so that the compressed refrigerant passes through the inner condenser and radiates heat while exchanging heat with the air in the vehicle; and the control unit may control the second multi-way valve and adjusts the opening degree of the first expansion valve and the opening degree of the second expansion valve so that the refrigerant, which has radiated heat while passing through the inner condenser flows to the heat absorber, a part of the refrigerant passes through the heat exchanger and then flows to the second refrigerant line, and the remaining part of the refrigerant flows to the third refrigerant line.

The second heating mode may be a state of COP=1 in which the refrigerant flowing in the fifth refrigerant line and the refrigerant flowing in the third refrigerant line exchange heat with each other, and the refrigerant flowing in the first refrigerant line, the second refrigerant line, the third refrigerant line, and the fifth refrigerant line does not exchange heat with a separate coolant, and the second heating mode may be a state in which the refrigerant passing through the evaporator exchanges heat with the air circulating in the vehicle.

In a general heating mode, the control unit may allow the refrigerant discharged from the inner condenser through the first refrigerant line to flow to the second refrigerant line and the third refrigerant line without heat exchange in the heat absorber and then circulate to the first refrigerant line again; the control unit may operate the compressor so that the compressed refrigerant passes through the inner condenser and radiates heat while exchanging heat with the air in the vehicle, and the control unit may control the second multi-way valve and adjusts the opening degree of the first expansion valve and the opening degree of the second expansion valve so that the refrigerant, which has radiated heat while passing through the inner condenser, is prevented from flowing to the fifth refrigerant line, a part of the refrigerant passes through the heat exchanger and then flows to the second refrigerant line, and the remaining part of the refrigerant flows to the third refrigerant line.

According to an embodiment of the present disclosure, the heat exchange between the refrigerant at the downstream point of the inner condenser and the refrigerant at the downstream point of the flash tank raises the temperature of the refrigerant to be introduced into the compressor, which makes it possible to improve the operational efficiency of the compressor.

In addition, the heat absorber is provided to perform the heat exchange between the refrigerants to use the energy consumed by the compressor during the heating process, which makes it possible to implement the heating mode in the state of COP=1 without heat exchange between the refrigerant and a separate coolant.

Therefore, even in the initial heating process, the heating process may be performed by reducing the amount of use of a separate heater or without using the heater, which makes it possible to save energy and eliminate the configuration of the heater.

### BRIEF DESCRIPTION OF THE FIGURES

FIG. 1 is a circuit diagram illustrating a gas injection type heat management system for a vehicle according to an embodiment of the present disclosure.

FIG. 2A is a circuit diagram illustrating an operation in a general heating mode in the gas injection type heat management system for a vehicle according to the embodiment of the present disclosure.

FIG. 2B is a P-h diagram illustrating the operation in the general heating mode in the gas injection type heat management system for a vehicle according to the embodiment of the present disclosure.

FIG. 3A is a circuit diagram illustrating an operation in a first heating mode in the gas injection type heat management system for a vehicle according to the embodiment of the present disclosure.

FIG. 3B is a P-h diagram illustrating the operation in the first heating mode in the gas injection type heat management system for a vehicle according to the embodiment of the present disclosure.

FIG. 4A is a circuit diagram illustrating an operation in a second heating mode in the gas injection type heat management system for a vehicle according to the embodiment of the present disclosure.

FIG. 4B is a P-h diagram illustrating the operation in the second heating mode in the gas injection type heat management system for a vehicle according to the embodiment of the present disclosure.

FIG. 5 is a circuit diagram illustrating a gas injection type heat management system for a vehicle according to another embodiment of the present disclosure.

FIG. 6A is a circuit diagram illustrating an operation in a general heating mode in the gas injection type heat management system for a vehicle according to another embodiment of the present disclosure.

FIG. 6B is a P-h diagram illustrating the operation in the general heating mode in the gas injection type heat management system for a vehicle according to another embodiment of the present disclosure.

FIG. 7A is a circuit diagram illustrating an operation in a first heating mode in the gas injection type heat management system for a vehicle according to another embodiment of the present disclosure.

FIG. 7B is a P-h diagram illustrating the operation in the first heating mode in the gas injection type heat management system for a vehicle according to another embodiment of the present disclosure.

FIG. 8A is a circuit diagram illustrating an operation in a second heating mode in the gas injection type heat management system for a vehicle according to another embodiment of the present disclosure.

FIG. 8B is a P-h diagram illustrating the operation in the second heating mode in the gas injection type heat management system for a vehicle according to another embodiment of the present disclosure.

### DETAILED DESCRIPTION

Hereinafter, embodiments of the present disclosure will be described in more detail with reference to the accompanying drawings. However, the present disclosure is not limited to the exemplary embodiment disclosed herein but will be implemented in various forms. The exemplary embodiment of the present disclosure is provided so that the present disclosure is completely disclosed, and a person with ordinary skill in the art can fully understand the scope of the present disclosure. In the drawings, the same reference numerals refer to the same elements.

Meanwhile, unless otherwise specified in the description of the embodiment of the present disclosure, positions of the respective constituent elements will be described depending on a flow direction of a fluid such as a coolant and a refrigerant. For example, a constituent element, through which the fluid passes relatively first, is understood as being positioned at an upstream point, and a constituent element, through which the fluid passes relatively later, is understood as being positioned at a downstream point.

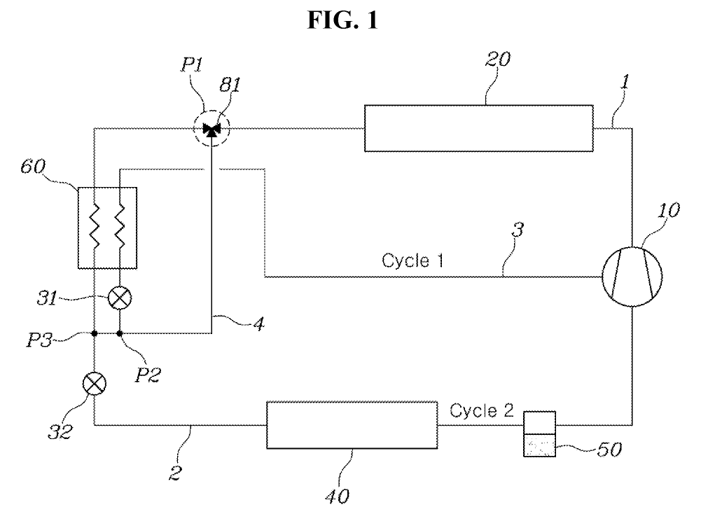

FIG. 1 is a circuit diagram illustrating a gas injection type heat management system for a vehicle according to an embodiment of the present disclosure.

As illustrated in FIG. 1, a gas injection type heat management system for a vehicle according to the embodiment of the present disclosure includes a first refrigerant line 1 in which a compressor 10, an inner condenser 20, and a heat exchanger 60 are sequentially provided and a refrigerant flows.

Further, the gas injection type heat management system includes a second refrigerant line 2 in which a second expansion valve 32 and an evaporator 40 are sequentially provided, and the refrigerant flows from the first refrigerant line 1 and circulates to the compressor 10 via the second expansion valve 32 and the evaporator 40. In this case, in the second refrigerant line 2, a gas-liquid separator 50 may be further provided at a downstream point of the evaporator 40, i.e., between the evaporator 40 and the compressor 10.

In addition, a second branch point P3 is provided in the second refrigerant line 2 and disposed at a downstream point of the heat exchanger 60.

Therefore, a third refrigerant line 3 branches off from the second branch point P3 so that the refrigerant flows directly to the compressor 10 via a first expansion valve 31 and the heat exchanger 60. In the heat exchanger 60, the refrigerant discharged from the inner condenser 20 and the refrigerant discharged from the first expansion valve 31 exchange heat with each other.

Further, a first branch point P1 is provided in the first refrigerant line 1 and disposed at a downstream point of the inner condenser 20. A first junction point P2 is provided in the third refrigerant line 3 and disposed at an upstream point of the first expansion valve 31.

A fourth refrigerant line 4 branches off from the first branch point P1 and merges into the first junction point P2.

In this embodiment, a first multi-way valve 81 configured to control flows in three directions is provided at the first branch point P1 in the first refrigerant line 1 and controls a flow direction of the refrigerant so that the refrigerant flows to the first refrigerant line 1 or the fourth refrigerant line 4. Therefore, the first multi-way valve 81 may be a 3-way valve.

The compressor 10 is a means for compressing the refrigerant introduced from the second refrigerant line 2 and the third refrigerant line 3 and converting the refrigerant into a high-pressure refrigerant. In this embodiment, a gas injection type compressor is applied as the compressor 10.

The inner condenser 20 is installed in an interior air conditioning device of the vehicle and exchanges heat between the compressed refrigerant passing through the inner condenser 20 and the air to be supplied to the interior of the vehicle. Further, the inner condenser 20 radiates the heat of the refrigerant into the air to be supplied to the interior of the vehicle, thereby heating the interior of the vehicle.

The first expansion valve 31 and the second expansion valve 32 each serve to block or permit the flow of the refrigerant and adjust an opening degree thereof to expand the refrigerant while the refrigerant flows.

The evaporator 40 exchanges heat between the refrigerant and the air recirculating to the interior space of the vehicle. The evaporator 40 serves to absorb heat from the air recirculating to the interior space of the vehicle and raise a temperature of the refrigerant.

The gas-liquid separator (accumulator) 50 separates a gas-phase refrigerant and a liquid-phase refrigerant contained in the refrigerant and introduces only the gas-phase refrigerant into the compressor 10.

The heat exchanger 60 exchanges heat between the refrigerants. In the present embodiment, the heat exchange is performed such that the refrigerant discharged from the first expansion valve 31 absorbs the heat from the refrigerant discharged from the inner condenser 20.

Meanwhile, a control unit (not illustrated) is further provided. The control unit controls whether to operate the compressor 10, whether to open or close the first expansion valve 31, and whether to open or close the second expansion valve 32. The control unit controls whether to allow the refrigerant to flow and whether to expand the refrigerant by adjusting the opening degree, and controls whether to open or close the first multi-way valve 81.

The gas injection type heat management system for a vehicle according to the embodiment of the present disclosure, configured as described above, may implement various modes under the control of the control unit.

Hereinafter, embodiments of various modes implemented by the gas injection type heat management system for a vehicle will be described with reference to the drawings.

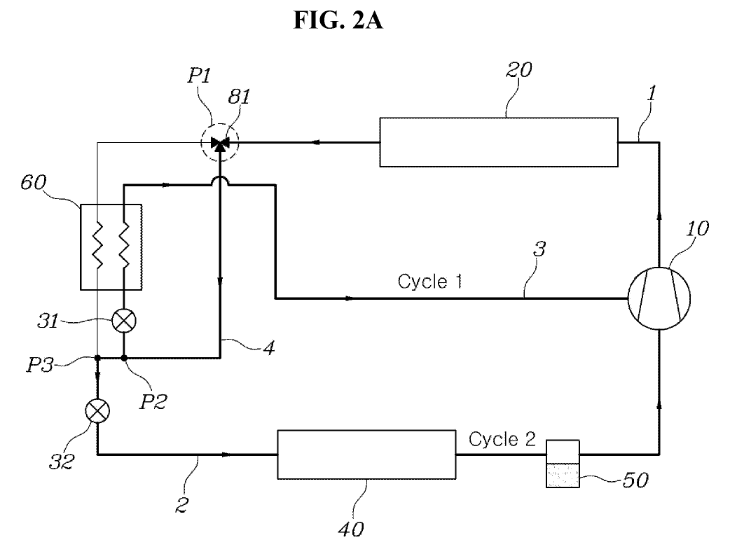

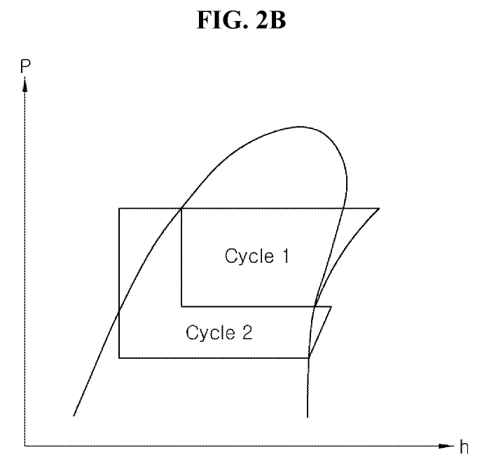

FIG. 2A is a circuit diagram illustrating an operation of a general heating mode in the gas injection type heat management system for a vehicle according to the embodiment of the present disclosure, and FIG. 2B is a P-h diagram illustrating the general heating mode in the gas injection type heat management system for a vehicle according to the embodiment of the present disclosure.

As illustrated in FIGS. 2A and 2B, the general heating mode is a heating mode in which a flow rate of the refrigerant circulating during the heating process is increased by circulating the refrigerant to the second refrigerant line 2 and the third refrigerant line 3 without heat exchange in the heat exchanger 60.

In this embodiment, the refrigerant discharged from the inner condenser 20 through the first refrigerant line 1 flows through the fourth refrigerant line 4, flows to the second refrigerant line 2 and the third refrigerant line 3, and then circulates through the first refrigerant line 1 again.

Therefore, the control unit operates the compressor 10 so that the compressed refrigerant radiates heat while exchanging heat with the air inside the vehicle while passing through the inner condenser 20.

In addition, the control unit controls the first multi-way valve 81 and allows the refrigerant to flow to the fourth refrigerant line 4. Further, the control unit may fully open the first expansion valve 31 so that the refrigerant passes through the first expansion valve 31 without being expanded. Alternatively, the control unit may adjust the opening degree of the first expansion valve 31 so that the refrigerant passing through the first expansion valve 31 is expanded.

In addition, the control unit adjusts the opening degree of the second expansion valve 32 so that the refrigerant flowing to the second refrigerant line 2 is expanded.

Therefore, the refrigerant discharged from the inner condenser 20 flows to the fourth refrigerant line 4 and then merges into the third refrigerant line 3 at the first junction point P2, such that a part of the refrigerant flows to the third refrigerant line 3, and the remaining part of the refrigerant flows to the second refrigerant line 2.

Therefore, the refrigerant compressed by the compressor 10 is cooled by radiating heat while exchanging heat with the air in the vehicle while passing through the inner condenser 20. A part of the low-temperature, high-pressure refrigerant is converted into the low-temperature, low-pressure refrigerant by being expanded while passing through the first expansion valve 31, and the low-temperature, low-pressure refrigerant is introduced directly into the compressor 10 (Cycle 1).

Further, the remaining part of the low-temperature, high-pressure refrigerant having passed through the inner condenser 20 is expanded while passing through the second expansion valve 32 and then converted into the high temperature, low-pressure refrigerant by passing through the evaporator 40 and absorbing, in the evaporator 40, the heat from the air circulating in the vehicle. The high-temperature, low-pressure refrigerant, which absorbs heat in the evaporator 40, passes through the gas-liquid separator 50, such that the liquid-phase refrigerant is separated, and only the gas-phase refrigerant is introduced back into the compressor 10 (Cycle 2).

A part of the refrigerant having passed through the inner condenser 20 passes through the first expansion valve 31 and then flows directly into the compressor 10. The remaining part of the refrigerant absorbs the heat while passing through the evaporator 40 and then flows into the compressor 10. Therefore, it is possible to increase the flow rate of the refrigerant circulating during the heating process and thus improve the heating efficiency.

Next, first and second heating modes in which the refrigerant flows to the heat absorber so that the heat exchange is performed between the refrigerants will be described.

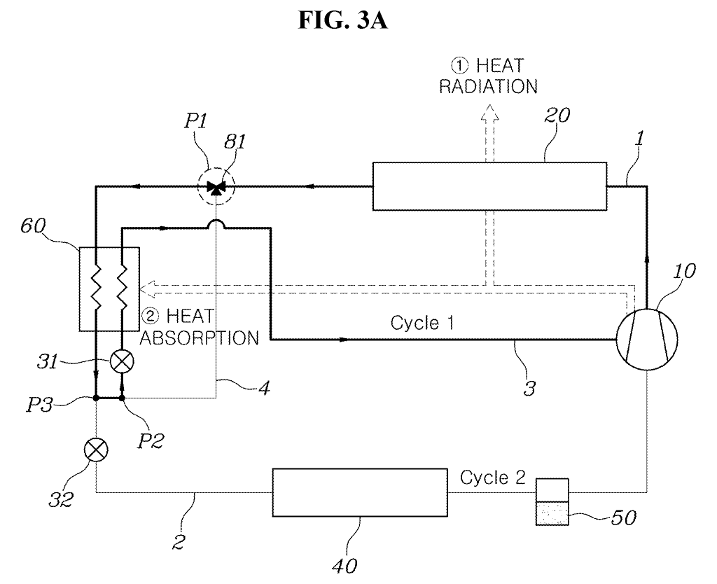

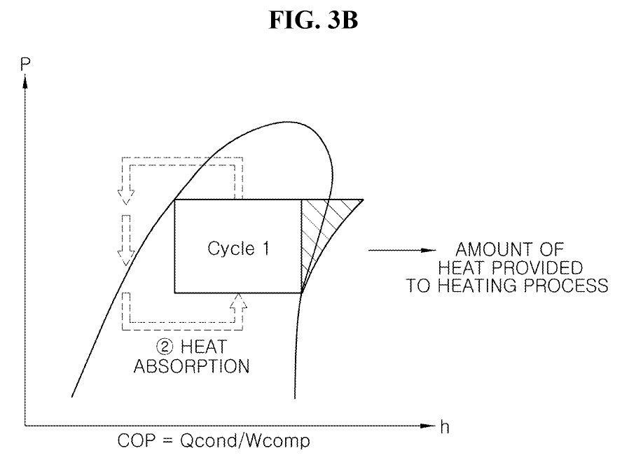

FIG. 3A is a circuit diagram illustrating an operation in a first heating mode in the gas injection type heat management system for a vehicle according to the embodiment of the present disclosure, and FIG. 3B is a P-h diagram illustrating the operation in the first heating mode in the gas injection type heat management system for a vehicle according to the embodiment of the present disclosure.

As illustrated in FIGS. 3A and 3B, the first heating mode is a heating mode in which a state of COP=1 is implemented such that the refrigerant flowing in the first refrigerant line 1 and the refrigerant flowing in the third refrigerant line 3 exchange heat with each other, whereas the refrigerant flowing in the first and third refrigerant lines 1 and 3 does not exchange heat with a separate coolant.

In the first heating mode, in the heat exchanger 60, the refrigerant discharged from the first expansion valve 31 absorbs the heat from the refrigerant discharged from the inner condenser 20.

To this end, after the refrigerant flows through the first refrigerant line 1, the refrigerant circulates to the first refrigerant line 1 again through the third refrigerant line 3, and the flow of the refrigerant to the second and fourth refrigerant lines 2 and 4 is blocked.

Therefore, the control unit operates the compressor 10 so that the compressed refrigerant radiates heat while exchanging heat with the air inside the vehicle while passing through the inner condenser 20.

Further, the control unit controls the operation of opening or closing the first multi-way valve 81 so that the refrigerant, which has radiated heat while passing through the inner condenser 20, flows to the heat exchanger but is prevented from flowing to the fourth refrigerant line 4, such that the refrigerant flows to the third refrigerant line 3.

In addition, the control unit adjusts the opening degree of the first expansion valve 31 so that the refrigerant, which has radiated heat while passing through the inner condenser 20 and has passed through the heat exchanger 60, is expanded while passing through the first expansion valve 31 and then introduced into the heat exchanger 60 again.

Meanwhile, the control unit fully closes the second expansion valve 32 to block the flow of the refrigerant to the second refrigerant line 2.

Therefore, the refrigerant compressed by the compressor 10 is cooled by radiating heat while exchanging heat with the air in the vehicle while passing through the inner condenser 20. The low-temperature, high-pressure refrigerant flows to the heat exchanger 60 through the first refrigerant line 1 and then is expanded while passing through the first expansion valve 31. The expanded refrigerant is introduced into the heat exchanger 60 again, such that the refrigerant introduced into the heat exchanger 60 directly from the inner condenser 20 exchanges heat with the refrigerant expanded while passing through the first expansion valve 31. Therefore, the refrigerant expanded while passing through the first expansion valve 31 absorbs the heat from the refrigerant introduced into the heat exchanger 60 directly from the inner condenser 20.

Further, the refrigerant, which has absorbed heat in the heat exchanger 60, is introduced into and compressed by the compressor 10.

Since the heating process is performed using heat exchange energy between the refrigerants, the state of COP=1 may be implemented in which the heating process may be performed only by the energy consumed by the compressor 10 without heat exchange with a separate coolant.

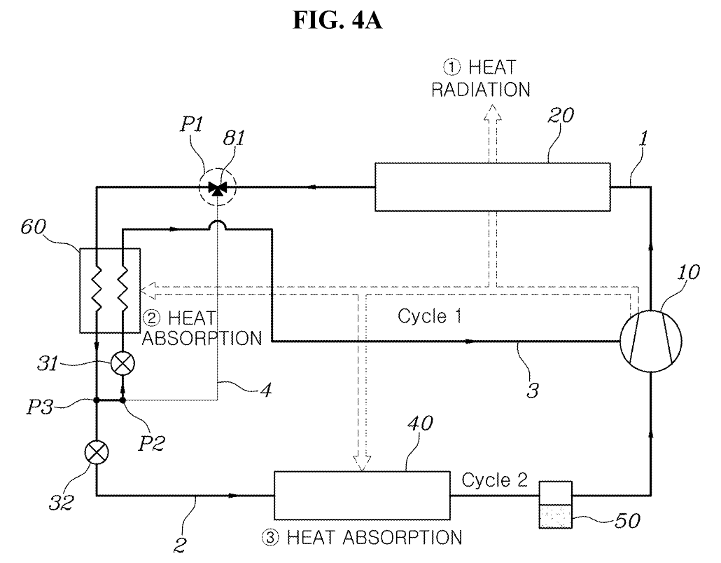

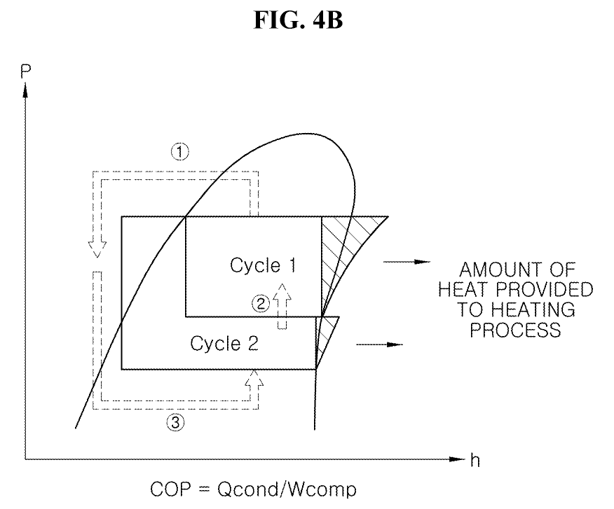

Next, FIG. 4A is a circuit diagram illustrating an operation in a second heating mode in the gas injection type heat management system for a vehicle according to the embodiment of the present disclosure, and FIG. 4B is a P-h diagram illustrating the operation in the second heating mode in the gas injection type heat management system for a vehicle according to the embodiment of the present disclosure.

As illustrated in FIGS. 4A and 4B, the second heating mode is a heating mode in which the state of COP=1 is implemented such that the refrigerant flowing in the first refrigerant line 1 and the refrigerant flowing in the third refrigerant line 3 exchange heat with each other, whereas the refrigerant flowing in the first refrigerant line 1, the second refrigerant line 2, and the third refrigerant line 3 does not exchange heat with a separate coolant. In the second heating mode, the heat exchange is performed between the refrigerant passing through the evaporator 40 and the air circulating in the vehicle, which makes it possible to further improve the heat pump efficiency and adjust the amount of moisture in the interior of the vehicle.

In the second heating mode, the refrigerant flowing in the second refrigerant line 2 absorbs, in the evaporator 40, the heat from the air circulating in the vehicle, and the refrigerant discharged from the first expansion valve 31 absorbs, in the heat exchanger 60, the heat from the refrigerant discharged from the inner condenser 20.

To this end, after the refrigerant flows through the first refrigerant line 1 and passes through the heat exchanger 60, a part of the refrigerant circulates to the first refrigerant line 1 again through the third refrigerant line 3, and the remaining part of the refrigerant circulates to the first refrigerant line 1 again through the second refrigerant line 2. In this case, the flow of the refrigerant to the fourth refrigerant line 4 is blocked.

Therefore, the control unit operates the compressor 10 so that the compressed refrigerant radiates heat while exchanging heat with the air inside the vehicle while passing through the inner condenser 20.

Further, the control unit controls the operation of opening or closing the first multi-way valve 81 so that the refrigerant, which has radiated heat while passing through the inner condenser 20, flows to the heat exchanger 60 but is prevented from flowing to the fourth refrigerant line 4, such that a part of the refrigerant flows to the third refrigerant line 3.

In addition, the control unit adjusts the opening degree of the first expansion valve 31 so that the refrigerant, which has radiated heat while passing through the inner condenser 20 and has passed through the heat exchanger 60, is expanded while passing through the first expansion valve 31 and then introduced into the heat exchanger 60 again.

Further, the control unit adjusts the opening degree of the second expansion valve 32 so that the refrigerant also flows to the second refrigerant line 2.

Therefore, the refrigerant compressed by the compressor 10 is cooled by radiating heat while exchanging heat with the air in the vehicle while passing through the inner condenser 20. The low-temperature, high-pressure refrigerant flows to the heat exchanger through the first refrigerant line 1, and then a part of the refrigerant is expanded while passing through the first expansion valve 31. The expanded refrigerant is introduced into the heat exchanger 60 again, such that the refrigerant introduced into the heat exchanger directly from the inner condenser 20 exchanges heat with the refrigerant expanded while passing through the first expansion valve 31. Therefore, the refrigerant expanded while passing through the first expansion valve 31 absorbs the heat from the refrigerant introduced into the heat exchanger directly from the inner condenser 20.

Further, the refrigerant, which has absorbed heat in the heat exchanger 60, is introduced into and compressed by the compressor 10.

In addition, the low-temperature, low-pressure refrigerant flowing to the second refrigerant line 2 from the heat exchanger 60 is converted into the high temperature, low-pressure refrigerant by absorbing heat while passing through the evaporator 40, and the high temperature, low-pressure refrigerant, together with the refrigerant having flowed in the third refrigerant line 3, is introduced into and compressed by the compressor 10.

Since the heating process may be performed by heat exchange energy between the refrigerants, it is possible to implement the state of COP=1 in which the heating process is performed only by the energy consumed by the compressor 10 without heat exchange with a separate coolant. The heating process is performed by the evaporator 40 absorbing the heat from the ambient air, which makes it possible to further improve the heat pump efficiency and adjust the amount of moisture in the interior.

Meanwhile, the present disclosure may further include the means that performs the heat exchange of the refrigerant, thereby improving the heat pump efficiency.

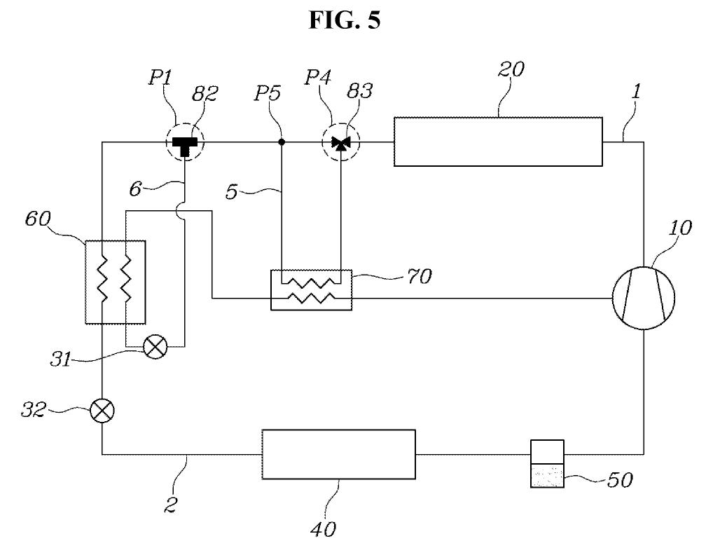

FIG. 5 is a circuit diagram illustrating a gas injection type heat management system for a vehicle according to another embodiment of the present disclosure.

As illustrated in FIG. 5, the gas injection type heat management system for a vehicle according to another embodiment of the present disclosure includes a first refrigerant line 1 in which a compressor 10, an inner condenser 20, and a heat exchanger 60 are sequentially provided and a refrigerant flows.

Further, the gas injection type heat management system includes a second refrigerant line 2 in which a second expansion valve 32 and an evaporator 40 are sequentially provided, and the refrigerant flows from the first refrigerant line 1 and circulates to the compressor 10 via the second expansion valve 32 and the evaporator 40. In this case, in the second refrigerant line 2, a gas-liquid separator 50 may be further provided at a downstream point of the evaporator 40, i.e., between the evaporator 40 and the compressor 10.

In addition, a first branch point P1 is provided in the first refrigerant line 1 and disposed at a downstream point of the inner condenser 20.

Therefore, a third refrigerant line 6 branches off from the first branch point P1 so that the refrigerant flows to the compressor via a first expansion valve 31 and the heat exchanger 60. In the heat exchanger 60, the refrigerant discharged from the inner condenser 20 and the refrigerant discharged from the first expansion valve 31 exchange heat with each other.

In this case, a heat absorber 70 is provided in the third refrigerant line 6 and disposed at a downstream point of the heat exchanger 60. In the heat absorber 70, the refrigerant discharged from the inner condenser 20 and the refrigerant flowing in the third refrigerant line 6 exchange heat with each other.

In this embodiment, the third branch point P4 is provided in the first refrigerant line 1 and disposed between the first branch point P1 and a downstream point of the inner condenser 20. A second junction point P5 is provided between the third branch point P4 and the first branch point P1.

Therefore, a fifth refrigerant line 5 branches off from the third branch point P4, passes through the heat absorber 70, and then merges into the second junction point P5.

In this embodiment, a T-tube 82 is provided at the first branch point P1 and separates the first refrigerant line 1 and the third refrigerant line 6. A second multi-way valve 83 is provided at the third branch point P4 and controls flow rates in three directions. Therefore, the flow direction of the refrigerant discharged from the inner condenser 20 is controlled so that the refrigerant flows to the first refrigerant line 1 or the fifth refrigerant line 5. Therefore, the second multi-way valve 83 may be a 3-way valve.

In this embodiment, because the compressor 10, the inner condenser 20, the first expansion valve 31, the second expansion valve 32, the evaporator 40, the gas-liquid separator 50, the heat exchanger 60, and the controller are identical in configurations and functions to those described in the aforementioned embodiment, a repeated description thereof will be omitted.

Meanwhile, the heat absorber 70 exchanges heat between the refrigerants. In the present embodiment, the heat exchange is performed such that the refrigerant flowing in the third refrigerant line 6 absorbs the heat from the refrigerant discharged from the inner condenser 20.

The gas injection type heat management system for a vehicle according to another embodiment of the present disclosure configured as described above may implement various modes under the control of the control unit.

Hereinafter, embodiments of various modes implemented by the gas injection type heat management system for a vehicle will be described with reference to the drawings.

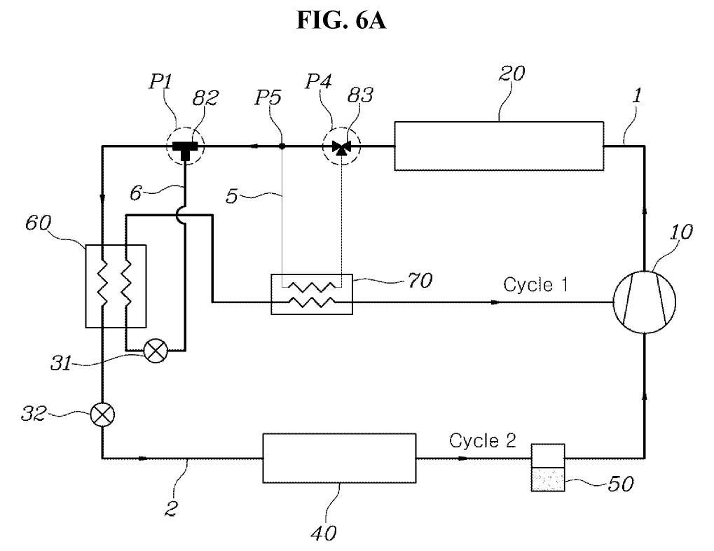

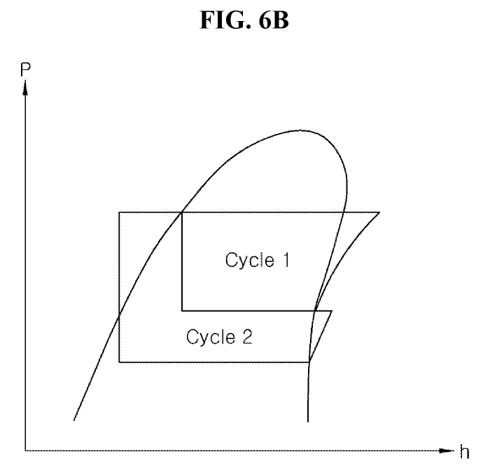

FIG. 6A is a circuit diagram illustrating an operation of a general heating mode in the gas injection type heat management system for a vehicle according to another embodiment of the present disclosure, and FIG. 6B is a P-h diagram illustrating the general heating mode in the gas injection type heat management system for a vehicle according to another embodiment of the present disclosure.

As illustrated in FIGS. 6A and 6B, the general heating mode is a heating mode in which a flow rate of the refrigerant circulating during the heating process is increased by circulating the refrigerant to the second refrigerant line 2 and the third refrigerant line 6 without heat exchange in the heat absorber 70.

In this embodiment, the refrigerant discharged from the inner condenser 20 through the first refrigerant line 1 flows to the second refrigerant line 2 and the third refrigerant line 6 and then circulates to the first refrigerant line 1 again.

Therefore, the control unit operates the compressor 10 so that the compressed refrigerant radiates heat while exchanging heat with the air inside the vehicle while passing through the inner condenser 20.

In addition, the control unit controls the second multi-way valve 83 and allows the refrigerant to flow to the second refrigerant line 2 and the third refrigerant line 6 while preventing the refrigerant from flowing to the fifth refrigerant line 5. Further, the control unit may adjust the opening degree of the first expansion valve 31 and the opening degree of the second expansion valve 32 so that the refrigerant passing through the first expansion valve 31 and the second expansion valve 32 is expanded.

Therefore, a part of the refrigerant discharged from the inner condenser 20 flows to the third refrigerant line 6, and the remaining part of the refrigerant flows directly to the heat exchanger 60.

Therefore, in the heat exchanger 60, the refrigerant flowing to the first refrigerant line 1 and the refrigerant flowing to the third refrigerant line 6 exchange heat with each other. The refrigerant flowing to the third refrigerant line 6 is introduced into the compressor 10 without heat exchange in the heat absorber 70 (Cycle 1).

Further, the refrigerant, which has passed through the heat exchanger 60 through the first refrigerant line 1, is expanded while passing through the second expansion valve 32 and then passes through the evaporator 40 while absorbing, in the evaporator 40, the heat from the air circulating in the vehicle. The refrigerant, which absorbs heat in the evaporator 40, passes through the gas-liquid separator 50, such that the liquid-phase refrigerant is separated, and only the gas-phase refrigerant is introduced back into the compressor 10 (Cycle 2).

A part of the refrigerant having passed through the inner condenser 20 passes through the first expansion valve 31, absorbs heat in the heat exchanger 60, and then flows into the compressor 10. The remaining part of the refrigerant radiates heat in the heat exchanger 60 and then absorbs the heat from the surrounding air while passing through the evaporator 40. Further, the refrigerant, which has absorbed heat in the evaporator 40, is introduced into the compressor 10. Therefore, it is possible to increase the flow rate of the refrigerant circulating during the heating process and thus improve the heating efficiency.

Next, first and second heating modes in which the refrigerant flows to the heat absorber so that the heat exchange is performed between the refrigerants will be described.

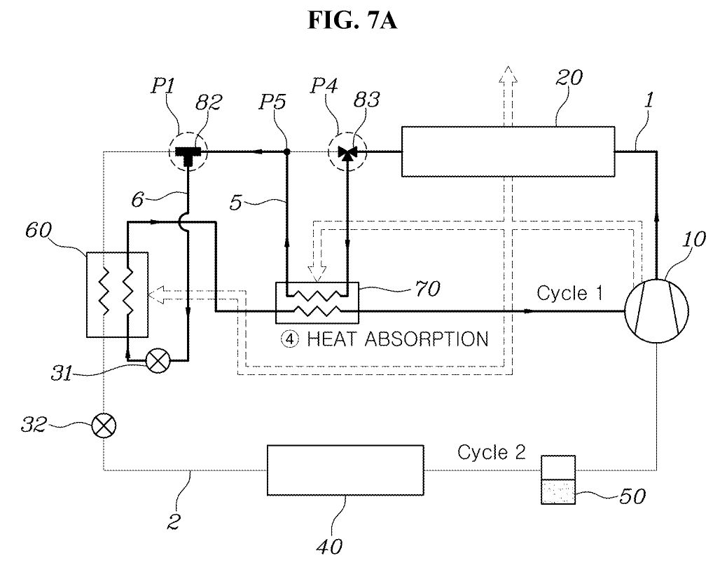

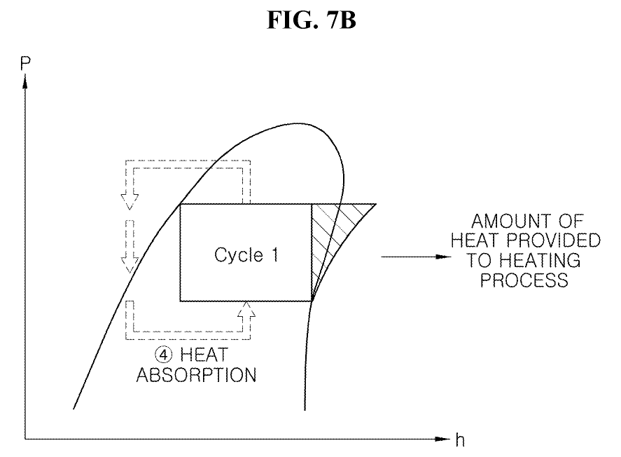

FIG. 7A is a circuit diagram illustrating an operation in a first heating mode in the gas injection type heat management system for a vehicle according to another embodiment of the present disclosure, and FIG. 7B is a P-h diagram illustrating the operation in the first heating mode in the gas injection type heat management system for a vehicle according to another embodiment of the present disclosure.

As illustrated in FIGS. 7A and 7B, the first heating mode is a heating mode in which a state of COP=1 is implemented such that the refrigerant flowing in the fifth refrigerant line 5 and the refrigerant flowing in the third refrigerant line 6 exchange heat with each other, whereas the refrigerant flowing in the first refrigerant line 1, the third refrigerant line 6, and the fifth refrigerant line 5 does not exchange heat with a separate coolant.

In the first heating mode, in the heat absorber 70, the refrigerant discharged from the first expansion valve 31 absorbs the heat from the refrigerant discharged from the inner condenser 20.

To this end, the refrigerant flowing to the first refrigerant line 1 flows to the fifth refrigerant line 5 and then circulates to the third refrigerant line 6, and the flow of the refrigerant to the heat exchanger 60 and the second refrigerant line 2 is blocked.

Therefore, the control unit operates the compressor 10 so that the compressed refrigerant radiates heat while exchanging heat with the air inside the vehicle while passing through the inner condenser 20.

Further, the control unit fully closes the second expansion valve 32 so that the refrigerant, which has radiated heat while passing through the inner condenser 20, flows to the heat absorber 70 but is prevented from flowing to the heat exchanger 60 and the second refrigerant line 2. The control unit controls the operation of opening or closing the second multi-way valve 83 so that the refrigerant flows to the fifth refrigerant line 5.

In addition, the control unit adjusts the opening degree of the first expansion valve 31 so that the refrigerant, which has radiated heat while passing through the inner condenser 20, exchanges heat, in the heat absorber 70, with the refrigerant expanded while passing through the first expansion valve 31.

Therefore, the refrigerant compressed by the compressor 10 is cooled by radiating heat while exchanging heat with the air in the vehicle while passing through the inner condenser 20. The low-temperature high-pressure refrigerant flows to the heat absorber 70 through the fifth refrigerant line 5 and then is expanded while passing through the first expansion valve 31. The expanded refrigerant is introduced into the heat absorber 70 again through the third refrigerant line 6, such that the refrigerant introduced into the heat absorber 70 directly from the inner condenser 20 exchanges heat with the refrigerant expanded while passing through the first expansion valve 31. Therefore, the refrigerant expanded while passing through the first expansion valve 31 absorbs the heat from the refrigerant introduced into the heat absorber 70 directly from the inner condenser 20.

Further, the refrigerant, which has absorbed heat in the heat absorber 70, is introduced into and compressed by the compressor 10.

Since the heating process is performed using heat exchange energy between the refrigerants, the state of COP=1 may be implemented in which the heating process may be performed only by the energy consumed by the compressor 10 without heat exchange with a separate coolant.

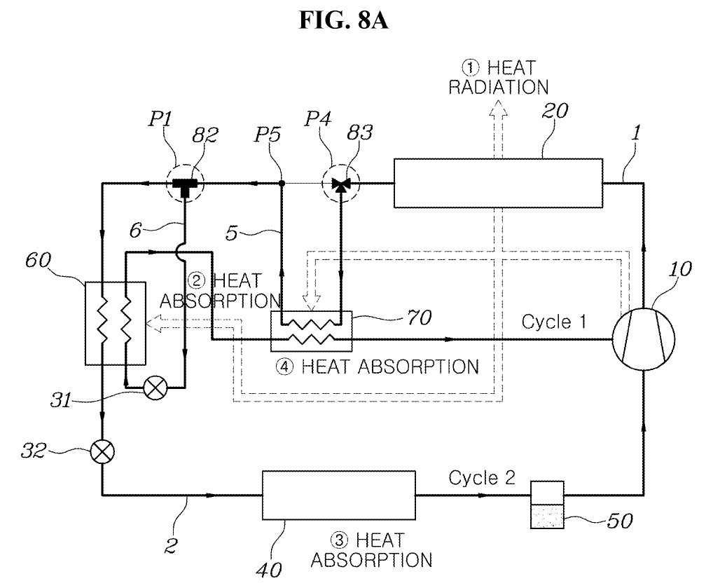

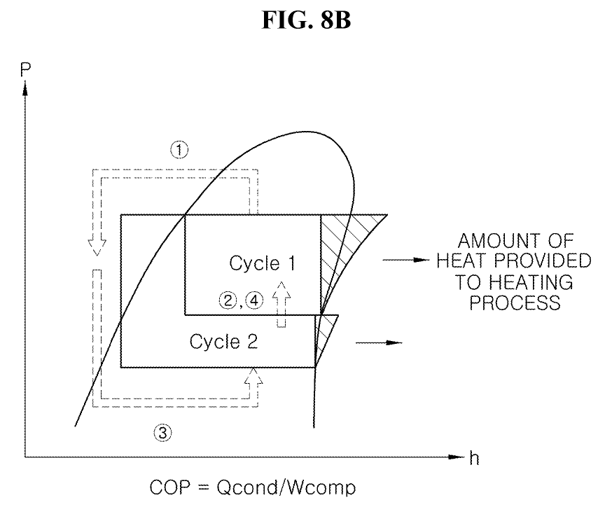

Next, FIG. 8A is a circuit diagram illustrating an operation in a second heating mode in the gas injection type heat management system for a vehicle according to another embodiment of the present disclosure, and FIG. 8B is a P-h diagram illustrating the operation in the second heating mode in the gas injection type heat management system for a vehicle according to another embodiment of the present disclosure.

As illustrated in FIGS. 8A and 8B, the second heating mode is a heating mode in which a state of COP=1 is implemented such that the refrigerant flowing in the fifth refrigerant line 5 and the refrigerant flowing in the third refrigerant line 6 exchange heat with each other, whereas the refrigerant flowing in the first refrigerant line 1, the second refrigerant line 2, the third refrigerant line 6, and the fifth refrigerant line 5 does not exchange heat with a separate coolant. In the second heating mode, the heat exchange is performed between the refrigerant passing through the evaporator 40 and the air circulating in the vehicle, which makes it possible to further improve the heat pump efficiency and adjust the amount of moisture in the interior of the vehicle.

In the second heating mode, the refrigerant flowing in the second refrigerant line 2 absorbs, in the evaporator 40, the heat from the air circulating in the vehicle, and the refrigerant discharged from the first expansion valve 31 absorbs, in the heat absorber 70, the heat from the refrigerant discharged from the inner condenser 20.

Further, in the heat exchanger 60, the refrigerant discharged from the first expansion valve 31 absorbs the heat from the refrigerant having passed through the heat absorber 70 through the fifth refrigerant line 5.

To this end, after the refrigerant flowing to the first refrigerant line 1 flows to the fifth refrigerant line 5, a part of the refrigerant circulates to the second refrigerant line 2, and the remaining part of the refrigerant circulates to the third refrigerant line 6.

Therefore, the control unit operates the compressor 10 so that the compressed refrigerant radiates heat while exchanging heat with the air inside the vehicle while passing through the inner condenser 20.

Further, the control unit controls the operation of opening or closing the second multi-way valve 83 so that the refrigerant, which has radiated heat while passing through the inner condenser 20, flows to the heat absorber 70, a part of the refrigerant, which has exchanged heat in the heat absorber 70, passes through the heat exchanger 60 and then flows to the second refrigerant line 2, and the remaining part of the refrigerant flows to the third refrigerant line 6.

In addition, the control unit adjusts the opening degree of the first expansion valve 31 and the opening degree of the second expansion valve 32 so that the refrigerant is expanded while passing through the first expansion valve 31 and the second expansion valve 32.

Therefore, the refrigerant compressed by the compressor 10 is cooled by radiating heat while exchanging heat with the air in the vehicle while passing through the inner condenser 20. The low-temperature, high-pressure refrigerant flows to the heat absorber 70 through the fifth refrigerant line 5, and a part of the refrigerant having passed through the heat absorber 70 is expanded while passing through the first expansion valve 31. In addition, a part of the refrigerant having passed through the heat absorber 70 is introduced directly into the heat exchanger 60.

Therefore, in the heat exchanger 60, the refrigerant introduced directly into the heat exchanger 60 exchanges heat with the refrigerant expanded while passing through the first expansion valve 31.

Further, the refrigerant, which has absorbed heat by exchanging heat while passing through the heat exchanger 60, flows to the heat absorber 70 again through the third refrigerant line 6 and absorbs heat by exchanging heat again with the refrigerant introduced into the heat absorber 70 directly from the inner condenser 20.

The refrigerant, which has absorbed heat in the heat exchanger 60 and the heat absorber 70, is introduced into and compressed by the compressor 10.

Meanwhile, the refrigerant flowing to the second refrigerant line 2 from the heat exchanger 60 absorbs heat while passing through the evaporator 40, and the refrigerant, which has absorbed heat in the evaporator 40, together with the refrigerant having flowed to the third refrigerant line 6, is introduced into and compressed by the compressor 10.

Since the heating process may be performed by heat exchange energy between the refrigerants, it is possible to implement the state of COP=1 in which the heating process is performed only by the energy consumed by the compressor without heat exchange with a separate coolant. The heating process is performed by the evaporator 40 absorbing the heat from the ambient air, which makes it possible to further improve the heat pump efficiency and adjust the amount of moisture in the interior.

The control unit according to the exemplary embodiment of the present disclosure may be implemented by a non-volatile memory (not illustrated) configured to store an algorithm for controlling operations of various constituent elements in a vehicle or store data related to software commands for executing the algorithm, and by a processor (not illustrated) configured to perform the following operations by using the data stored in the corresponding memory. In this case, the memory and the processor may be implemented as separate chips. Alternatively, the memory and the processor may be implemented as a single chip in which the memory and the processor are integrated. The processor may be configured in the form of one or more processors.

While the present disclosure has been described with reference to the accompanying drawings and the aforementioned exemplary embodiments, but the present disclosure is not limited thereto but defined by the appended claims. Therefore, those skilled in the art can variously change and modify the present disclosure without departing from the technical spirit of the appended claims.

1. A gas injection heat management system for a vehicle, the gas injection type heat management system comprising:
a first refrigerant line in which a compressor, an inner condenser, and a heat exchanger are sequentially provided and a refrigerant flows;
a second refrigerant line in which a second expansion valve and an evaporator are sequentially provided such that the refrigerant flows from the first refrigerant line and circulates to the compressor via the second expansion valve and the evaporator;
a third refrigerant line in which a first branch point is disposed in the first refrigerant line and provided at a downstream point of the inner condenser based on a flow direction of the refrigerant, the third refrigerant line branching off from the first branch point such that the refrigerant flows to the compressor via a first expansion valve and the heat exchanger, and in the heat exchanger, the refrigerant discharged from the inner condenser and the refrigerant discharged from the first expansion valve exchange heat with each other; and
a control unit configured to control whether to operate the compressor and control whether to allow the refrigerant to flow and whether to expand the refrigerant by adjusting an opening degree of the first expansion valve and an opening degree of the second expansion valve.

2. The gas injection heat management system of claim 1, wherein a heat absorber is further provided in the third refrigerant line and disposed at a downstream point of the heat exchanger and allows the refrigerant discharged from the inner condenser and the refrigerant flowing in the third refrigerant line to exchange heat with each other, a third branch point is disposed in the first refrigerant line and provided between the first branch point and the downstream point of the inner condenser based on the flow direction of the refrigerant, a second junction point is provided between the third branch point and the first branch point, a fifth refrigerant line is further provided to branch off from the third branch point, pass through the heat absorber, and then merge into the second junction point, and a second multi-way valve is provided at the third branch point and controls flow rates in three directions.

3. The gas injection heat management system of claim 2, wherein in a first heating mode, the control unit allows the refrigerant flowing to the first refrigerant line to pass through the fifth refrigerant line and then circulate to the third refrigerant line again, and the control unit prevents the refrigerant from flowing to the heat exchanger and the second refrigerant line, such that in the heat absorber, the refrigerant discharged from the first expansion valve absorbs heat from the refrigerant discharged from the inner condenser.

4. The gas injection heat management system of claim 3, wherein in the first heating mode, the control unit operates the compressor so that the compressed refrigerant passes through the inner condenser and radiates heat while exchanging heat with air in the vehicle;
the control unit fully closes the second expansion valve so that the refrigerant, which has radiated heat while passing through the inner condenser, flows to the heat absorber and is prevented from flowing to the heat exchanger and the second refrigerant line;
the control unit controls an operation of opening or closing the second multi-way valve so that the refrigerant flows to the fifth refrigerant line; and
the control unit adjusts the opening degree of the first expansion valve so that the refrigerant, which has radiated heat while passing through the inner condenser, exchanges, in the heat absorber, heat with the refrigerant expanded while passing through the first expansion valve.

5. The gas injection heat management system of claim 3, wherein the first heating mode is a state of COP=1 in which the refrigerant flowing in the fifth refrigerant line and the refrigerant flowing in the third refrigerant line exchange heat with each other, and the refrigerant flowing in the fifth refrigerant line and the third refrigerant line does not exchange heat with a separate coolant.

6. The gas injection heat management system of claim 2, wherein in a second heating mode, the control unit allows the refrigerant flowing to the first refrigerant line to flow to the fifth refrigerant line, a part of the refrigerant to circulate to the second refrigerant line, and the remaining part of the refrigerant to circulate to the third refrigerant line, such that the refrigerant flowing in the second refrigerant line absorbs, in the evaporator, heat from air circulating in the vehicle, the refrigerant discharged from the first expansion valve absorbs, in the heat absorber, heat from the refrigerant discharged from the inner condenser, and the refrigerant discharged from the first expansion valve absorbs, in the heat exchanger, heat from the refrigerant having passed through the heat absorber through the fifth refrigerant line.

7. The gas injection heat management system of claim 6, wherein in the second heating mode, the control unit operates the compressor so that the compressed refrigerant passes through the inner condenser and radiates heat while exchanging heat with the air in the vehicle; and
the control unit controls the second multi-way valve and adjusts the opening degree of the first expansion valve and the opening degree of the second expansion valve so that the refrigerant, which has radiated heat while passing through the inner condenser flows to the heat absorber, a part of the refrigerant passes through the heat exchanger and then flows to the second refrigerant line, and the remaining part of the refrigerant flows to the third refrigerant line.

8. The gas injection heat management system of claim 6, wherein the second heating mode is a state of COP=1 in which the refrigerant flowing in the fifth refrigerant line and the refrigerant flowing in the third refrigerant line exchange heat with each other, and the refrigerant flowing in the first refrigerant line, the second refrigerant line, the third refrigerant line, and the fifth refrigerant line does not exchange heat with a separate coolant, and
wherein the second heating mode is a state in which the refrigerant passing through the evaporator exchanges heat with the air circulating in the vehicle.

9. The gas injection heat management system of claim 2, wherein in a general heating mode, the control unit allows the refrigerant discharged from the inner condenser through the first refrigerant line to flow to the second refrigerant line and the third refrigerant line without heat exchange in the heat absorber and then circulate to the first refrigerant line again;
the control unit operates the compressor so that the compressed refrigerant passes through the inner condenser and radiates heat while exchanging heat with the air in the vehicle; and
the control unit controls the second multi-way valve and adjusts the opening degree of the first expansion valve and the opening degree of the second expansion valve so that the
refrigerant, which has radiated heat while passing through the inner condenser, is prevented from flowing to the fifth refrigerant line, a part of the refrigerant passes through the heat exchanger and then flows to the second refrigerant line, and the remaining part of the refrigerant flows to the third refrigerant line.
